(19) United States
(12) Patent Application Publication
(10) Pub. No.: US 2020/0077690 A1
(43) Pub. Date: Mar. 12, 2020

(54) Exogenous Ketone Composition

(71) Applicant: Ross Steinberg, Beverly Hills, CA (US)

(72) Inventor: Ross Steinberg, Beverly Hills, CA (US)

(21) Appl. No.: 16/562,842

(22) Filed: Sep. 6, 2019

Related U.S. Application Data
(60) Provisional application No. 62/727,660, filed on Sep. 6, 2018.

(51) Int. Cl. A23L 29/00; A23L 33/125; A23L 33/175

(52) U.S. Cl. CPC A23L 29/035; A23L 33/125; A23L 29/015; A23L 33/175; A23L 29/045

(57) ABSTRACT

A composition of exogenous ketones is provided which comprises one or more exogenous ketone bodies as well as one or more carbohydrates. More particularly, the one or more ketone bodies comprises beta-hydroxybutyrate, which provides a fuel source, and the one or more carbohydrates comprises resistant starch, which provides additional energy while preserving glycogen reserves and without causing insulin generation. In other embodiments, the carbohydrates comprise glucose, fructose, or other regular carbohydrates. The ketone bodies may also comprise acetoacetate and/or acetone. Unlike many conventional products, which spike blood sugar and result in an insulin surge, thereby blocking fat metabolism until the insulin and sugar is depleted, the inventive composition increases energy, improves insulin sensitivity, and enhances physical endurance during increased physical activity. Moreover, unlike other products, while the composition provides fuel, it also allows fat metabolism to continue for the duration of the exercise. In further embodiments, additional ingredients, such as protein, caffeine, and electrolytes may be included to provide additional energy, restore electrolyte levels, and offer other benefits.

### CROSS-REFERENCE TO RELATED APPLICATIONS

Pursuant to 35 U.S.C. § 120, this patent application relies on the benefit of U.S. Patent App. No. 62/727,660 filed on Sep. 6, 2018. The content of said application is incorporated herein by reference in its entirety.

### GOVERNMENT CONTRACT

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to ketone supplement compositions and, more particularly, to a composition for athletic performance enhancement.

### BACKGROUND

Ketosis is the metabolic response to an energy crisis and also, a mechanism by which to sustain life by altering oxidative fuel selection. Energy crises can occur in response to prolonged fasting, starvation, ketogenic diets, and other conditions of reduced carbohydrate availability thereby causing ketone bodies, namely acetoacetate, acetone, and beta-hydroxybutyrate, to be produced in the liver. These ketone bodies serve as an alternative fuel source to carbohydrates and fat by replacing glucose utilization in peripheral tissues. Ketone bodies also act as signaling metabolites to regulate gene expression and adaptive responses to exercise. Moreover, ketone bodies hold the potential to lower plasma lactate levels induced by exercise, which in turn indicates decreased reliance on anaerobic carbohydrate metabolism for energy needs.

Supplementing the diet with key compounds to improve physical performance and body composition is a common practice. Some of the most popular compounds used today for this purpose include caffeine, beta-alanine, creatine, and other compounds that elicit acute ergogenic effects. For instance, U.S. Patent Publication No. 2001/0041187 to Hastings et al. discloses a dietary supplement comprising soy protein isolate. Such dietary supplements can lead to digestive discomfort and problems associated with excess consumption of protein, such as dehydration, kidney disease, and osteoporosis. On the other hand, intentional nutritional ketosis has shown efficacy in facilitating weight loss and promoting endurance performance in both recreational and competitive athletes alike. Indeed, ketosis conserves glucose reserves while simultaneously satisfying the fuel demands of the brain and body. The metabolic demands of prolonged physical exertion mirror those important to survival during periods of starvation. Thus, fuel sparing and energetic efficiency is desirable for sustaining physical performance.

The physiological and bioenergetic benefits of nutritional ketosis has enabled the adoption of exogenous ketone supplementation to aid in athletic performance. For instance, U.S. Patent Publication No. 2015/0065571 to Clarke et al. teaches the use of a ketone body and a ketone body ester for preserving glycogen and protein within muscles, thereby improving endurance and promoting muscle recovery. This disclosure, however, does not teach the use of a carbohydrate in conjunction with exogenous ketones in order to provide the continual fat metabolism of the present invention.

### SUMMARY

The present disclosure is directed to a composition for a ketone supplement comprising a mixture of one or more exogenous ketones and one or more carbohydrates. Although the term “supplement” is used throughout this disclosure to describe the composition, a person of ordinary skill in the art will recognize that this language should not serve to limit the scope of this invention. Indeed, the composition described herein may be formed in any number of ways so as to introduce the mixture into a person's body. In an exemplary embodiment, the composition may comprise beta-hydroxybutyrate and resistant starch. In alternate embodiments, the one or more exogenous ketone bodies may comprise acetoacetate or acetone. In still other embodiments, the resistant starch may comprise amylose, amylopectin, or a combination thereof. Alternatively, the one or more carbohydrates may comprise glucose, fructose, or any other carbohydrate.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

It is a primary object of this disclosure to provide an exogenous ketone composition, which increases energy and improves performance during exercise, while causing continual fat metabolism and improving insulin sensitivity. Moreover, the exogenous ketone composition may reduce muscle breakdown during exercise and aid muscle recovery afterward.

In accordance with one embodiment, the composition may include between about 1% to about 99% by weight exogenous ketones and between about 1% to about 99% by weight resistant starch. In some embodiments, the composition may more specifically comprise between about 25% to about 45% by weight of the one or more exogenous ketone bodies and between about 55% to about 75% by weight of the one or more carbohydrates.

In an embodiment, the composition may further comprise one or more non-starch monosaccharides, oligosaccharides, or polysaccharides, which may facilitate the amount of resistant starch reaching the terminal point of the large intestine.

In another embodiment, the composition may further comprise protein, such as collagen, whey, beef, egg, casein, or vegan protein, to enhance lean muscle building and also, support hormone levels, aid neurotransmitter production, and strengthen bones. In other embodiments, the composition may comprise one or more individual amino acids.

In yet another embodiment, the composition further may comprise caffeine to provide additional energy and improve alertness. In other embodiments, the composition may comprise other central nervous system stimulants.

In still another embodiment, the composition may further comprise one or more electrolytes to mitigate electrolyte imbalance and dehydration often experienced with ketosis or a ketogenic diet. In certain embodiments, the one or more electrolytes may be sodium, potassium, magnesium, calcium, or a combination of the foregoing.

One or more of the above-disclosed embodiments, in addition to certain alternatives, are provided in further detail below with reference to the attached figures. The disclosed subject matter is not, however, limited to any particular embodiment disclosed.

### Advantages

Several advantages of one or more aspects are to provide an exogenous ketone composition that:

(a) improves performance during exercise;

(b) aids muscle recovery after exercise;

(c) serves as an alternative fuel source;

(d) reduces muscle and protein breakdown during exercise;

(e) increases muscle protein synthesis;

(f) lowers levels of inflammation;

(g) protects against cardiovascular diseases, diabetes, and other diseases;

(h) provides energy substrate;

(i) enhances memory and cognitive functions;

(j) improves insulin sensitivity;

(k) increases satiety/decrease hunger;

(l) replenishes electrolytes;

(m) lowers blood sugar levels;

(n) provides continual fat metabolism; and

(o) delays usage of stored muscle and liver glycogen.

These and other advantages of one or more aspects will become apparent from consideration of the ensuing description and accompanying examples. Although the description above contains many specifics, these should not be construed as limiting the scope of the embodiments but as merely providing illustrations of some of several embodiments. Thus, the scope of the embodiments should be determined by the claims that are appended and their legal equivalents, rather than by examples given.

The description of the invention which follows, together with the accompanying examples should not be construed as limiting the invention to the examples shown and described, because those skilled in the art to which this invention pertains will be able to devise other forms thereof within the ambit of the appended claims.

### DETAILED DESCRIPTION

Illustrative embodiments of the invention are described below. The showings are for purposes of illustrating preferred embodiments and not for purposes of limiting the same. The following explanation provides specific details for a thorough understanding of an enabling description for these embodiments. One skilled in the art will understand that the invention may be practiced without such details. In other instances, well-known structures and functions have not been shown or described in detail to avoid unnecessarily obscuring the description of the embodiments.

In an embodiment, the composition for ketone supplementation may comprise one or more exogenous ketone bodies and carbohydrates. In some embodiments, the one or more exogenous ketone bodies may comprise beta-hydroxybutyrate and the carbohydrates may comprise resistant starch.

In one embodiment, the composition may comprise between about 1 to about 99% by weight of the one or more exogenous ketones and between about 1 to about 99% by weight of the carbohydrates. More particularly, the composition may further comprise between about 30 to about 50% by weight of the one or more ketone bodies and between about 50 to about 70% by weight of the carbohydrates. Moreover, in certain embodiments, the composition may comprise about 550 to about 600 mg of the one or more ketone bodies per kilogram of body mass.

The one or more exogenous ketone bodies may comprise beta-hydroxybutyrate, which may be processed by the body efficiently. While the term “beta-hydroxybutyrate” is used throughout this disclosure, a person of ordinary skill in the art will understand that beta-hydroxybutyrate is also known as beta-hydroxybutyric acid, 3-hydroxybutyrate or even, C₄H₈O₃. Moreover, beta-hydroxybutyrate may be present as either of its two optical isoforms, that is, a D-isoform, an L-isoform, or a racemic mixture of both beta-hydroxybutyrate isoforms.

Beta-hydroxybutyrate may aid in the preservation of carbohydrate and glycogen fuel reserves by serving as an alternative fuel source to carbohydrates and fat. In some embodiments, beta-hydroxybutyrate may also reduce muscle glycogen and protein breakdown as well as decrease plasma lactate concentrations. Beta-hydroxybutyrate may further be broken down more easily by the body and thereby, require less oxygen for consumption. Thus, beta-hydroxybutyrate may provide ergogenic support for high-intensity exercise through improved energetic efficiency and fuel sparing. Moreover, the one or more exogenous ketone bodies may elevate endogenous blood ketone levels, thereby facilitating ketosis. One of ordinary skill in the art will recognize other ketone bodies, such as acetoacetate and acetone, may be possible in accordance with this invention.

The one or more exogenous ketone bodies may be formed and digestible as a mineral salt, an ester, or an oil. In certain embodiments, the one or more exogenous ketones may comprise a ketone body bonded to a mineral ion or salt, such as sodium, calcium, potassium, or magnesium. In certain exemplary embodiments, the one or more exogenous ketone bodies may comprise beta-hydroxybutyrate bonded to sodium. In embodiments where the salt may be sodium, sodium may assist normal nerve and muscle function and maintain fluid balance as well as blood pressure and volume. In other embodiments where the salt may be calcium, calcium may support cardiovascular health and improve bone mineral density. In alternate embodiments wherein the salt may be magnesium, magnesium may maintain muscle and nerve function, support a healthy immune system, normalize heart rate, regulate blood glucose levels, and allow for energy production and protein synthesis. Moreover, magnesium may improve strength, muscle metabolism, and in turn, athletic performance and recovery.

In such embodiments where the beta-hydroxybutyrate may be bonded to a salt, the exogenous ketones may taste more palatable and may be easier to administer. More particularly, when the one or more ketone bodies may be bonded to a salt, the ketone bodies may then be easily blended into water or another drinkable liquid for consumption. Thus, in some embodiments, the composition may be formed as a powder so as to dissolve readily in water.

In other embodiments, the beta-hydroxybutyrate may be in raw form, that is, the beta-hydroxybutyrate may be formed as an ester. More particularly, in embodiments where the exogenous ketone bodies may be formed as ketone esters, the exogenous ketones may comprise a raw ketone molecule, such as beta-hydroxybutyrate or acetoacetate, bonded to a ketone precursor, such as butanediol or glycerol, using an ester bond. In some of such embodiments, the exogenous ketone bodies may comprise acetoacetate diester (otherwise known as 1,3-butanediol acetoacetate diester), which is comprised of acetoacetate and butanediol. As another example, the exogenous ketone bodies may comprise beta-hydroxybutyrate monoester (otherwise known as R-1,3-butanedoil-R-3-hydroxybutyrate), which is comprised of beta-hydroxybutyrate bonded to butanediol. In ester form, the beta-hydroxybutyrate may be utilized by the body more readily than when bonded to a salt, thereby raising blood ketone levels more drastically.

In yet other embodiments, the exogenous ketone compound may be formed as an oil, which may provide long-acting energy but may be first broken down by the body prior to utilization as energy. In this way, the ketone oil may serve as a ketogenic precursor by stimulating or maintaining ketone production. In such embodiments, the compound may comprise a ketone oil, such as a medium chain triglyceride (MCT) oil or coconut oil, which may cause endogenous ketone levels to increase. Further, the MCT oil may comprise caproic acid, caprylic acid, capric acid, lauric acid, or a combination of the foregoing.

As mentioned previously, the compound may further comprise one or more carbohydrates. In certain preferred embodiments, the carbohydrates may comprise resistant starch. In particular, the resistant starch may comprise any starch that is not digested in the small intestine but that passes to the large bowel. The resistant starch may comprise amylose, amylopectin, or a combination thereof.

For example, the resistant starch may comprise a Type 2 resistant starch, such as raw potato starch, green banana starch, gingko starch, high-amylose maize starch, or a combination thereof. A person of ordinary skill in the art will understand any of the four types of resistant starches may be possible in accordance with this invention. Specifically, the resistant starch may comprise a Type 1 resistant starch, such as that derived from whole grains, seeds, or legumes. In another embodiment, the resistant starch may comprise a Type 3 resistant starch, that is, a resistant starch that has become such through cooling of cooked starches, such as potatoes or rice. In yet other embodiments, the resistant starch may comprise a Type 4 resistant starch, such as those chemically modified or created. Moreover, the one or more carbohydrates may comprise a combination of one or more of the four types of resistant starch. While a person of ordinary skill in the art will recognize resistant starch is preferable due to its synergistic qualities, other regular carbohydrates may be utilized in accordance with this invention.

One of ordinary skill in the art will understand that the resistant starch may be a starch that cannot be digested by the enzymes, such as amylases, in the human small intestine. As a result, the resistant starch may pass to the colon to be fermented by microbiota, thereby producing important metabolites. In turn, colon cancer precursors may be reduced, macronutrient metabolism may be regulated, and secretion of hormones may be altered.

The resistant starch may also lower blood sugar levels after food consumption, thereby improving insulin sensitivity. By avoiding the need for insulin generation while being metabolized, the resistant starch may provide continual fat metabolism for energy. The resistant starch may also increase satiety and decrease hunger. Moreover, the resistant starch may reduce fat storage, lower plasma low-density lipoprotein cholesterol levels, and feed the good bacteria of the gut. In alternate embodiments, the one or more carbohydrates may comprise a regular carbohydrate, such as glucose or fructose.

In some embodiments, the composition may also comprise one or more non-starch polysaccharides, oligosaccharides or monosaccharides, which may facilitate the amount of resistant starch that reaches the lower colon and feces. The non-starch polysaccharides may further produce energy and short-chain fatty acids through fermentation by bacteria in the large intestine. The non-starch polysaccharides may comprise pectin, cellulose, gums, or hemicelluloses, such as, for example, wheat bran, wheat seed, or acacia fiber. The non-starch monosaccharides may be digested more quickly than a polysaccharide and thereby, may cause the composition to take effect sooner.

In some embodiments, the composition may further comprise one or more amino acids, or protein. In certain embodiments, the amino acids comprise essential amino acids, such as histidine, isoleucine, leucine, lysine, methionine, phenylalanine, threonine, tryptophan, and valine. The amino acids may also comprise non-essential amino acids, such as alanine, arginine, asparagine, aspartic acid, cysteine, glutamine, glutamic acid, and glycine.

The amino acids may aid in maintenance, growth, recovery, and regeneration of muscles. The amino acids may also support brain function by enhancing neurotransmitter production and hormonal balance by supporting optimal levels of peptide hormones. Similarly, the amino acids may regulate appetite, sleep, and mood. In addition, the amino acids may maintain the myelin sheath, which is the protective barrier that surrounds nerve cells. The amino acids may further aid in immune function, energy regulation, and hemoglobin production. Moreover, the amino acids may also play a role in fat metabolism as well as, absorption of vital minerals. Furthermore, the amino acids may strengthen bones, thereby reducing the risk of fractures and osteoporosis.

In embodiments wherein the composition comprises protein, one of ordinary skill in the art will recognize a variety of types of protein may be adapted in accordance with this disclosure. More particularly, in some embodiments, the protein may comprise collagen protein. Collagen protein may enhance lean muscle building and also support hair, skin, nails, and other bodily tissues. In other embodiments, the protein may comprise whey protein, beef protein, egg protein, or casein protein. In still other embodiments, the protein may comprise one or more vegan proteins, including seed proteins, such as those derived from hemp, sunflower seed, pumpkin seed, flax, chia, or sesame seeds; legume and grain proteins, such as those derived from peas, millet, brown rice, buckwheat, quinoa, or garbanzo beans; alfalfa protein; or goji protein.

In certain embodiments, the composition may further comprise caffeine as an additional energy source and to promote alertness. The caffeine may be derived from any number of sources, such as tea leaves (black, green, oolong, and white), coffee beans, cacao, green coffee beans (coffee arabica), guarana, kola nut, yerba mate, dicaffeine malate, caffeine citrate, caffeine anhydrous, or 1,3,7-trimethylxanthine. In some embodiments, caffeine may be formed as caffeine anhydrous. In addition to providing energy, caffeine may increase stamina during exercise and relieve post-exercise muscle pain. Caffeine may also improve reaction time, enhance memory consolidation, and prevent weight gain by stimulating fat metabolism. Moreover, when combined with the one or more carbohydrates, caffeine may replenish muscle glycogen concentrations following exercise or physical activity. In certain embodiments, another central nervous system stimulant, other than caffeine, may be incorporated into the composition.

Moreover, in other embodiments, one or more electrolytes may be included. For example, the composition may further comprise sodium, potassium, calcium, magnesium, chloride, hydrogen phosphate, and hydrogen carbonate. In certain exemplary embodiments, the composition may comprise a combination of sodium, potassium, calcium, and magnesium. One of ordinary skill in the art will understand that the amount of the one or more electrolytes may vary so as to provide a composition which is safe for multiple ingestions per day.

The one or more electrolytes may maintain the proper gradient of electrolytes. The electrolytes may thereby counteract the diuretic effects concomitant of a low-carbohydrate diet and replenish depleted endogenous electrolyte and water stores. Moreover, the electrolytes may regulate the blood pH and are critical for nerve and muscle function. In still other embodiments, the composition may also comprise one or more vitamins or other nutritional ingredients.

The aforementioned composition may be mixed together, or otherwise formulated, by conventional methods known to those skilled in the art. Moreover, the composition may be placed into a pharmaceutically acceptable carrier. In an exemplary embodiment, the inventive composition may be formed into liquid or powder form. In such embodiments, the composition may be dissolved in water. In other embodiments, a food product, such as yogurt or a dairy beverage, may act as the carrier. Indeed, yogurt and other dairy sources may prove ideal carriers due to their ability to prevent degradation in the gut. The food product may be in solid or liquid/drinkable form. In some of these embodiments, the composition may be carried in a chewable form or even a gel, such as those commonly consumed by runners. In still other embodiments, the composition may be formed into a pill or tablet.

In alternate embodiments, the composition may be formed so as to be deliverable by a number of means. For instance, as discussed immediately above, the composition may be formed so as to be delivered orally, through the swallowing of a pill, beverage, or food product. Additionally, the composition may be formed so as to be delivered intravenously, sublingually, perineurally, transcutaneously, transdermally, or even, topically.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### EXAMPLES OF THE PREFERRED EMBODIMENT

In order to more fully teach what the Applicant regards as his invention, the following example is given. It should be understood that the formulations set forth in this Example is not to be construed as limiting of the scope of the invention, except so far as they yield an exogenous ketone composition having the desired properties and characteristics. The following ingredients are an example of Applicant's invention with the percentages being given by weight of the composition:

| Ingredient | Percentage |
|---|---|
| Beta-hydroxybutyrate | 32.25% |
| Resistant starch | 60.48% |
| Sodium | 5.32% |
| Magnesium | 0.30% |
| Calcium | 0.62% |
| Potassium | 1.03% |
| TOTAL: | 100.0% |

### CONCLUSIONS, RAMIFICATIONS, AND SCOPE

While certain embodiments of the invention have been illustrated and described, various modifications are contemplated and can be made without departing from the spirit and scope of the invention. For example, the beta-hydroxybutyrate may be formed variously as an ester or an oil, or may be bonded to a salt. Further, the one or more ketone bodies may comprise other ketones, such as acetoacetate or acetone, in addition to or in substitution of beta-hydroxybutyrate. Accordingly, it is intended that the invention not be limited, except as by the appended claims.

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the exogenous ketone composition with which that terminology is associated. In general, the terms used in the following claims should not be constructed to limit the exogenous ketone composition to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the exogenous ketone composition is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the exogenous ketone composition.

What is claimed is:

1. An exogenous ketone composition comprising:
one or more ketone bodies; and
one or more carbohydrates.

2. The composition of claim 1, wherein the one or more ketone bodies is selected from the group consisting of beta-hydroxybutyrate, acetoacetate, and acetone.

3. The composition of claim 1, wherein the one or more carbohydrates is resistant starch.

4. The composition of claim 1, further comprising:
the one or more ketone bodies about 30.00 to about 50.00 wt. % of the composition;
the one or more carbohydrates about 50.00 to about 70.00 wt. % of the composition.

5. The composition of claim 1, wherein the composition is water-soluble.

6. A composition for enhancing athletic performance, comprising:
a mixture comprising: beta-hydroxybutyrate, resistant starch, and one or more electrolytes.

7. The composition of claim 6, wherein the mixture is water-soluble and formed as a powder.

8. The composition of claim 6, wherein the mixture is formed as a liquid or solid food product.

9. The composition of claim 6, further comprising a central nervous system stimulant.

10. The composition of claim 9, wherein the central nervous system stimulant is caffeine.

11. The composition of claim 6, further comprising one or more amino acids.

12. A water-soluble composition comprising:
one or more ketone bodies;
resistant starch;
caffeine; and
one or more electrolytes.

13. The composition of claim 12, wherein the one or more ketone bodies is bonded to a salt.

14. The composition of claim 13, wherein the salt is sodium.

15. The composition of claim 14, wherein the one or more ketone bodies is beta-hydroxybutyrate.

16. The composition of claim 15, further comprising:
up to 32 wt. % sodium beta-hydroxybutyrate;
up to 60.25 wt. % resistant starch;
up to 0.5 wt. % caffeine; and
up to 7.25 wt. % of the one or more electrolytes.

17. The composition of claim 6 or 12, wherein the one or more electrolytes comprise sodium, potassium, magnesium, and calcium.
